(19) United States
(12) Patent Application Publication
(10) Pub. No.: US 2021/0400311 A1
(43) Pub. Date: Dec. 23, 2021

(54) Method and Apparatus of Line Buffer Reduction for Neural Network in Video Coding

(71) Applicant: MEDIATEK INC., Hsinchu City (TW)

(72) Inventors: Yu-Ling HSIAO, Hsinchu City (TW); Ching-Yeh CHEN, Hsinchu City (TW); Tzu-Der CHUANG, Hsinchu City (TW); Chih-Wei HSU, Hsinchu City (TW); Yu-Wen HUANG, Hsinchu City (TW)

(21) Appl. No.: 16/903,453

(22) Filed: Jun. 17, 2020

(51) Int. Cl. H04N 19/90; H04N 19/80; H04N 19/176

(52) U.S. Cl. CPC H04N 19/90; H04N 19/176; H04N 19/80

(57) ABSTRACT

Methods and apparatus of video processing for a video coding system using Neural Network (NN) are disclosed. According to this method, a shifted region is determined for the filter region to avoid unavailable reconstructed or filtered-reconstructed video data for the NN processing of the filter region, where boundaries of the shifted region comprises region boundaries derived by shifting target boundaries upward, leftward, or both upward and leftward, and wherein the target boundaries correspond to one or more top boundaries and one or more left boundaries of target processing region including the current block and one or more remaining un-processed blocks. According to another method, the areas outside boundaries of pictures, slices, tiles, or tile groups are padded. In yet another method, a flag is used to indicate whether the NN processing is allowed to cross a boundary between two slices, two tiles or two tile groups.

### FIELD OF THE INVENTION

The invention relates generally to video coding. In particular, the present invention relates to methods and apparatus to reduce line buffer requirement for video coding systems utilizing Neural Network (NN).

### BACKGROUND AND RELATED ART

Neural Network (NN), also referred as an ‘Artificial’ Neural Network (ANN), is an information-processing system that has certain performance characteristics in common with biological neural networks. A Neural Network system is made up of a number of simple and highly interconnected processing elements to process information by their dynamic state response to external inputs. The processing element can be considered as a neuron in the human brain, where each perceptron accepts multiple inputs and computes weighted sum of the inputs. In the field of neural network, the perceptron is considered as a mathematical model of a biological neuron. Furthermore, these interconnected processing elements are often organized in layers. For recognition applications, the external inputs may correspond to patterns are presented to the network, which communicates to one or more middle layers, also called ‘hidden layers’, where the actual processing is done via a system of weighted ‘connections’.

Artificial neural networks may use different architecture to specify what variables are involved in the network and their topological relationships. For example the variables involved in a neural network might be the weights of the connections between the neurons, along with activities of the neurons. Feed-forward network is a type of neural network topology, where nodes in each layer are fed to the next stage and there is connection among nodes in the same layer. Most ANNs contain some form of ‘learning rule’, which modifies the weights of the connections according to the input patterns that it is presented with. In a sense, ANNs learn by example as do their biological counterparts. Backward propagation neural network is a more advanced neural network that allows backwards error propagation of weight adjustments. Consequently, the backward propagation neural network is capable of improving performance by minimizing the errors being fed backwards to the neural network.

The NN can be a deep neural network (DNN), convolutional neural network (CNN), recurrent neural network (RNN), or other NN variations. Deep multi-layer neural networks or deep neural networks (DNN) correspond to neural networks having many levels of interconnected nodes allowing them to compactly represent highly non-linear and highly-varying functions. Nevertheless, the computational complexity for DNN grows rapidly along with the number of nodes associated with the large number of layers.

The CNN is a class of feed-forward artificial neural networks that is most commonly used for analyzing visual imagery. A recurrent neural network (RNN) is a class of artificial neural network where connections between nodes form a directed graph along a sequence. Unlike feedforward neural networks, RNNs can use their internal state (memory) to process sequences of inputs. The RNN may have loops in them so as to allow information to persist. The RNN allows operating over sequences of vectors, such as sequences in the input, the output, or both.

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC).

In HEVC, one slice is partitioned into multiple coding tree units (CTU). The CTU is further partitioned into multiple coding units (CUs) to adapt to various local characteristics. HEVC supports multiple Intra prediction modes and for Intra coded CU, the selected Intra prediction mode is signaled. In addition to the concept of coding unit, the concept of prediction unit (PU) is also introduced in HEVC. Once the splitting of CU hierarchical tree is done, each leaf CU is further split into one or more prediction units (PUs) according to prediction type and PU partition. After prediction, the residues associated with the CU are partitioned into transform blocks, named transform units (TUs) for the transform process.

FIG. 1A illustrates an exemplary adaptive Intra/Inter video encoder based on HEVC. The Intra/Inter Prediction unit 110 generates Inter prediction based on Motion Estimation (ME)/Motion Compensation (MC) when Inter mode is used. The Intra/Inter Prediction unit 110 generates Intra prediction when Intra mode is used. The Intra/Inter prediction data (i.e., the Intra/Inter prediction signal) is supplied to the subtractor 116 to form prediction errors, also called residues or residual, by subtracting the Intra/Inter prediction signal from the signal associated with the input picture. The process of generating the Intra/Inter prediction data is referred as the prediction process in this disclosure. The prediction error (i.e., residual) is then processed by Transform (T) followed by Quantization (Q) (T+Q, 120). The transformed and quantized residues are then coded by Entropy coding unit 122 to be included in a video bitstream corresponding to the compressed video data. The bitstream associated with the transform coefficients is then packed with side information such as motion, coding modes, and other information associated with the image area. The side information may also be compressed by entropy coding to reduce required bandwidth. Since a reconstructed picture may be used as a reference picture for Inter prediction, a reference picture or pictures have to be reconstructed at the encoder end as well. Consequently, the transformed and quantized residues are processed by Inverse Quantization (IQ) and Inverse Transformation (IT) (IQ+IT, 124) to recover the residues. The reconstructed residues are then added back to Intra/Inter prediction data at Reconstruction unit (REC) 128 to reconstruct video data. The process of adding the reconstructed residual to the Intra/Inter prediction signal is referred as the reconstruction process in this disclosure. The output picture from the reconstruction process is referred as the reconstructed picture. In order to reduce artefacts in the reconstructed picture, in-loop filters including De-blocking Filter (DF) 130 and Sample Adaptive Offset (SAO) 132 are used. The filtered reconstructed picture at the output of all filtering processes is referred as a decoded picture in this disclosure. The decoded pictures are stored in Frame Buffer 140 and used for prediction of other frames.

FIG. 1B illustrates an exemplary adaptive Intra/Inter video decoder based on HEVC. Since the encoder also contains a local decoder for reconstructing the video data, some decoder components are already used in the encoder except for the entropy decoder. At the decoder side, an Entropy Decoding unit 160 is used to recover coded symbols or syntaxes from the bitstream. The process of generating the reconstructed residual from the input bitstream is referred as a residual decoding process in this disclosure. The prediction process for generating the Intra/Inter prediction data is also applied at the decoder side, however, the Intra/Inter prediction unit 150 is different from that in the encoder side since the Inter prediction only needs to perform motion compensation using motion information derived from the bitstream. Furthermore, an Adder 114 is used to add the reconstructed residues to the Intra/Inter prediction data.

During the development of the HEVC standard, another in-loop filter, called Adaptive Loop Filter (ALF), is also disclosed, but not adopted into the main standard. The ALF can be used to further improve the video quality. For example, ALF 210 can be used after SAO 132 and the output from ALF 210 is stored in the Frame Buffer 140 as shown in FIG. 2A for the encoder side and FIG. 2B at the decoder side. For the decoder side, the output from the ALF 210 can also be used as decoder output for display or other processing. In this disclosure, de-blocking filter, SAO and ALF are all referred as a filtering process.

Among different image restoration or processing methods, neural network based method, such as deep neural network (DNN) or convolution neural network (CNN), is a promising method in the recent years. It has been applied to various image processing applications such as image de-noising, image super-resolution, etc., and it has been proved that DNN or CNN can achieve a better performance compared to traditional image processing methods. Therefore, in the following, we propose to utilize CNN as one image restoration method in one video coding system to improve the subjective quality or coding efficiency. It is desirable to utilize NN as an image restoration method in a video coding system to improve the subjective quality or coding efficiency for emerging new video coding standards such as High Efficiency Video Coding (HEVC).

Among different image restoration or processing methods, Neural Network (NN) based method, such as DNN (deep fully-connected feed-forward neural network), CNN (convolution neural network), RNN (recurrent neural network), or other NN variations are promising methods. It has been applied for image de-noising, image super-resolution and it has been shown that neural network (NN) can help to achieve better performance compared to traditional image processing methods. While NN-based processing can improve the subjective quality or coding efficiency, the NN-based processing may require more line buffers. In particular, when the NN processing is applied to reconstructed video data or filtered-reconstructed video data (i.e., after DF, SAO or ALF), some reconstructed video data or filtered-reconstructed video data may have to be buffered since these data may not be available. The buffer (e.g., line buffer) will increase system cost. Therefore, in the following, various methods to reduce the line buffer requirements are disclosed. The methods disclosed can be applied video systems such as H.264, AVC and HEVC. Nevertheless, the methods disclosed can also be applied to any other video coding system (e.g. the emerging VVC (Versatile Video Coding) standard) incorporating an NN-based processing.

### BRIEF SUMMARY OF THE INVENTION

A method and apparatus of video processing for a video coding system using Neural Network (NN) are disclosed. According to this method, reconstructed or filtered-reconstructed video data associated with a filter region in a current picture are received for Neural Network (NN) processing, where the current picture is divided into multiple blocks and the multiple blocks are encoded or decoded on a block basis. For a current block being encoded or decoded, a shifted region is determined for the filter region to avoid unavailable reconstructed or filtered-reconstructed video data for the NN processing of the filter region, where boundaries of the shifted region comprises region boundaries derived by shifting target boundaries upward, leftward, or both upward and leftward, and wherein the target boundaries correspond to one or more top boundaries and one or more left boundaries of target processing region including the current block and one or more remaining un-processed blocks. The NN processing may correspond to DNN (deep fully-connected feed-forward neural network), CNN (convolution neural network), or RNN (recurrent neural network).

In one embodiment, the filter region corresponds to one picture, one slice, one coding tree unit (CTU) row, one CTU, one coding unit (CU), one prediction unit (PU), one transform unit (TU), one block, or one N×N block, where N corresponds to 4096, 2048, 1024, 512, 256, 128, 64, 32, 16, or 8. The current block may correspond to a coding tree unit (CTU).

In one embodiment, if a target pixel in the shifted region is outside the current picture, a current slice, a current tile, or a current tile group containing the current block, the NN processing is not applied to the target pixel.

In one embodiment, the filtered-reconstructed video data correspond to de-block filter (DF) processed data, DF and sample-adaptive-offset (SAO) processed data, or DF, SAO and adaptive loop filter (ALF) processed data.

According to another method, if a target pixel in the current processing region is not available for the NN processing, the target pixel is generated by a padding process. The padding process may correspond to nearest pixel copy, odd mirroring or even mirroring.

According to yet another method, a flag is determined for the filter region. The NN processing is applied to the filter region according to the flag, where the NN processing is applied across a target boundary when the flag has a first value and the NN processing is not applied across the target boundary when the flag has a second value. The flag is signalled at an encoder side or parsed at a decoder side.

In one embodiment, the flag is predefined. In another embodiment, the flag is explicitly transmitted in a higher-level of a bitstream corresponding to a sequence level, a picture level, a slice level, a tile level, or a tile group level. The flag at a higher level of a bitstream can be overwritten by the flag at a lower level of the bitstream.

### BRIEF DESCRIPTION OF THE DRAWINGS

FIG. 1A illustrates an exemplary adaptive Intra/Inter video encoder based on the High Efficiency Video Coding (HEVC) standard.

FIG. 1B illustrates an exemplary adaptive Intra/Inter video decoder based on the High Efficiency Video Coding (HEVC) standard.

FIG. 2A illustrates an exemplary adaptive Intra/Inter video encoder similar to that in FIG. 1A with an additional ALF process.

FIG. 2B illustrates an exemplary adaptive Intra/Inter video decoder similar to that in FIG. 1B with an additional ALF process.

FIG. 3 illustrates an example of unavailable samples (reconstructed or filtered-reconstructed samples) in processed CTUs, where the coding system uses neural network (NN) processing to restore the samples.

FIG. 4 illustrates an example of above-left shifted region (CTU), where samples in the shifted region may be outside the picture, slice, tile, or tile group.

FIG. 5 illustrates an example of above-left shifted region (CTU), where samples in the shifted region may not be outside the picture, slice, tile, or tile group.

FIG. 6 illustrates an example of above shifted region (CTU), where samples in the shifted region may be outside the picture, slice, tile, or tile group.

FIG. 7 illustrates an example of above shifted region (CTU), where samples in the shifted region may not be outside the picture, slice, tile, or tile group.

FIG. 8 illustrates an example of above-left shifted region region (CTU) near the bottom and right boundary of pictures, slices, tiles or tile groups, where the NN process is applied twice.

FIG. 9 illustrates an example of above-left shifted region region (CTU) near the bottom and right boundary of pictures, slices, tiles or tile groups, where the NN process is applied once.

FIG. 10 illustrates an example of applying the NN process across a boundary between two slices, tiles or tile groups.

FIG. 11 illustrates an example of above-left shifted control flag region (i.e., ¼ CTU).

FIG. 12 illustrates an example of control flag region (i.e., ¼ CTU) without shifting.

FIG. 13 illustrates an exemplary flowchart of video coding incorporating the neural network (NN) according to one embodiment of the present invention, where the filter region is shifted up, left or both up and left.

FIG. 14 illustrates an exemplary flowchart of video coding incorporating the neural network (NN) according to one embodiment of the present invention, where if a target pixel in the filter region is not available for the NN processing, the target pixel is generated by a padding process.

FIG. 15 illustrates an exemplary flowchart of video coding incorporating the neural network (NN) according to one embodiment of the present invention, where whether the NN processing can be applied across a target boundary depends on a flag.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

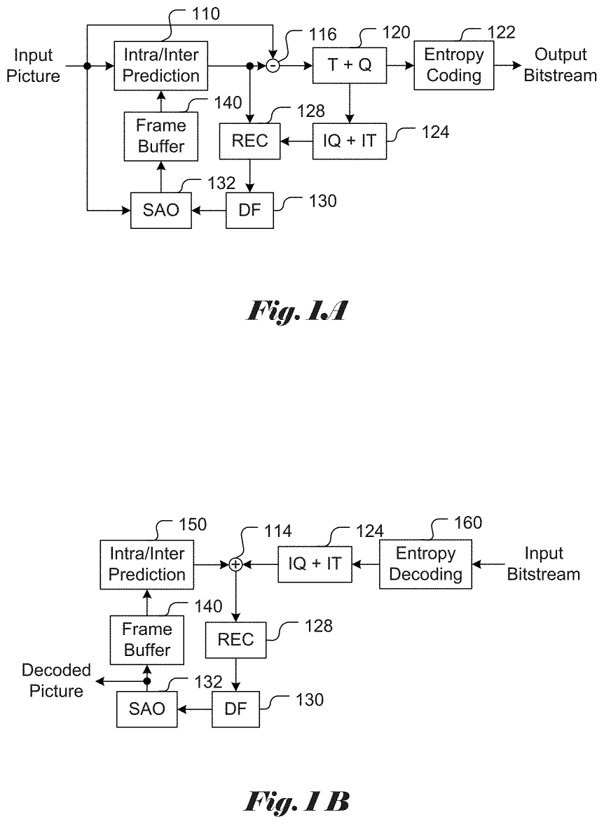

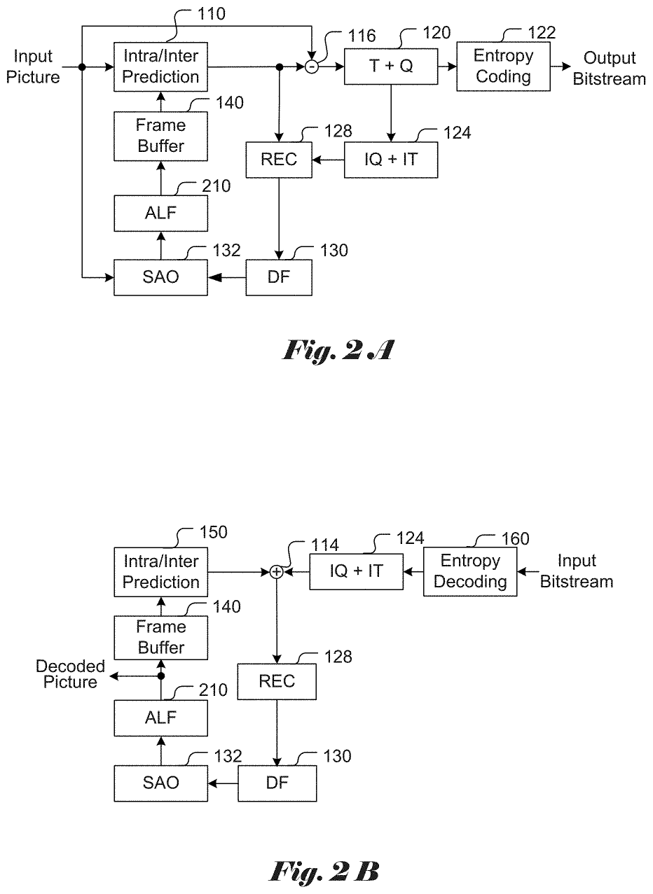

The proposed method is to utilize NN as an image restoration method in the video coding system. The NN can be DNN, CNN, RNN, or other NN variations. For example, as shown in FIG. 2A and FIG. 2B, the NN can be applied to ALF output picture to generate the final decoded picture. Alternatively, the NN can be directly applied after REC, DF, or SAO, with or without other restoration methods in the video coding system, as shown in FIG. 1 or FIG. 2.

The decoding process with NN-based restoration is to filter a region in the picture, wherein each region (also referred as filter region in the disclosure) corresponds to one picture, one slice, one CTU row, one CTU, one CU, one PU, one TU, one block, or one N-by-N block where N can be 4096, 2048, 1024, 512, 256, 128, 64, 32, 16, or 8. When NN is applied after loop filters, such as DF, SAO or ALF, there are some samples in a processed CTU that are not available until the right or below CTUs are processed, as shown in FIG. 3. In order to minimize the line buffer for storing samples in the CTU row, the shifted-region based NN processing is proposed. In FIG. 3, CTU 310 is the CTU being encoded or decoded. When the processing order is from left to right for each CTU row and moved down to the next CTU row, any CTU to the right or below the currently coded CTU 310 is not yet coded. The region for these CTUs already coded, as outlined by region 320, is referred as the target region for the NN processing in this disclosure. However, some data adjacent to the boundaries of CTU below or to the right are not available yet (labelled as “unavailable” in FIG. 3).

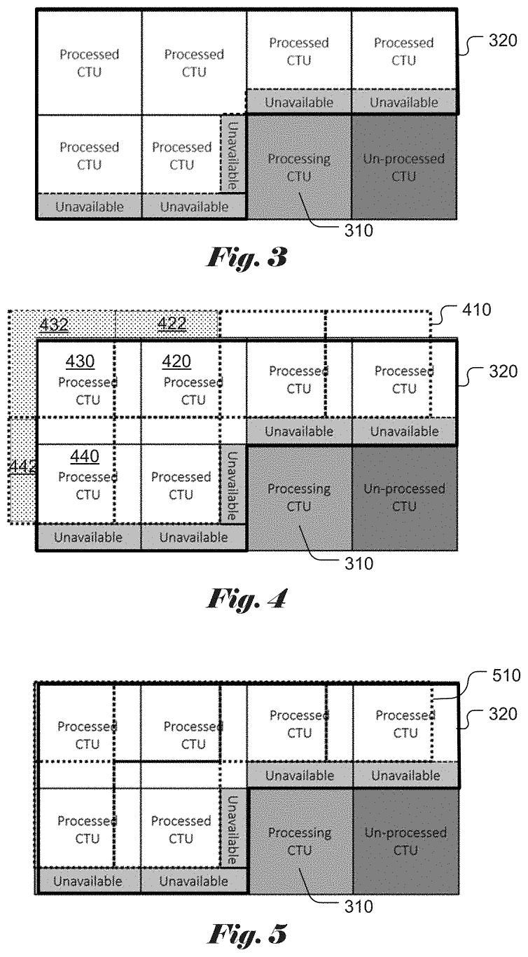

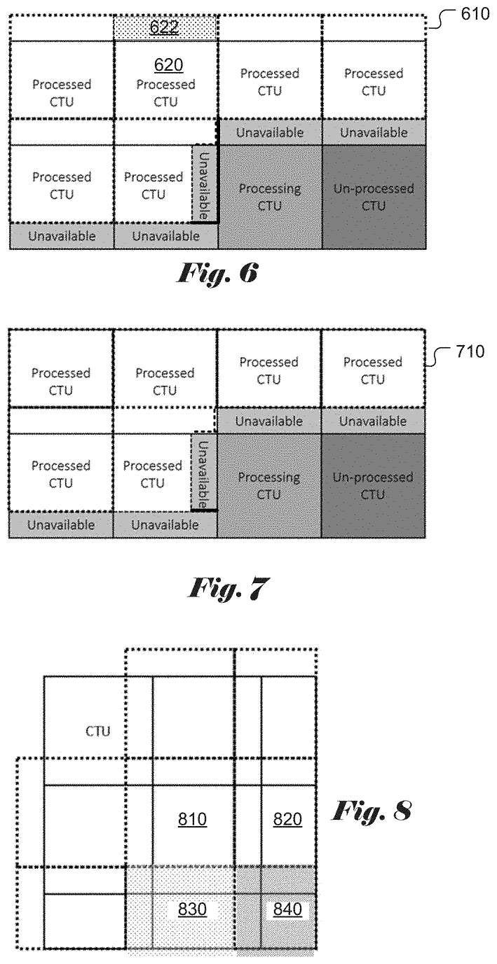

In one embodiment, as shown in FIG. 4 to FIG. 7, the region can be shifted toward above-left or above to let the region to avoid unavailable samples. The region can be processed by NN when the right CTU has finished and no need to wait the below CTU to finish. In one embodiment, the samples in a region outside boundaries of pictures, slices, tiles, or tile groups are specially handled. There are two solutions to solve this problem. One is to apply padding techniques to generate the corresponding pixels, as shown in FIG. 4 and FIG. 6. In FIG. 4, the above-left shifted region is indicated by dashed lines 410. For CTU 420, the above area 422 is outside a boundary of pictures, slices, tiles, or tile groups. Therefore, the area 422 is padded. Similarly, the outside area 432 for CTU 430 and outside area 442 for CTU 440 are padded according to one embodiment of the present invention. In FIG. 6, the above shifted region is indicated by dashed lines 610. For CTU 620, the above area 622 is outside a boundary of pictures, slices, tiles, or tile groups. Therefore, the area 622 is padded. The padding technique can be nearest pixel duplication, odd mirroring, or even mirroring. FIG. 4 and FIG. 6 illustrate examples of areas outside boundaries of pictures, slices, tiles, or tile groups due to region boundary shift. However, even without region boundary shift, the areas outside boundaries of pictures, slices, tiles, or tile groups may still occur since the NN process may use reconstructed or filtered-reconstructed pixels from neighboring blocks.

For the areas outside boundaries of pictures, slices, tiles, or tile groups, the other approach is to skip the NN process for these pixels. For example, the region for the NN process can be shrunk to be within the boundary of pictures, slices, tiles, or tile groups as shown in FIG. 5 and FIG. 7. In FIG. 5, the above-left shifted region with areas outside a boundary of pictures, slices, tiles, or tile groups is skipped as shown. Compared to FIG. 4, the region 510 (indicated by dashed lines) for the NN process according to this embodiment is shrunk to exclude the areas outside boundaries of pictures, slices, tiles, or tile groups. In FIG. 7, the above shifted region with areas outside a boundary of pictures, slices, tiles, or tile groups is shrunk as shown. Compared to FIG. 6, the region 710 (indicated by dashed lines) for the NN process according to this embodiment is shrunk to exclude the areas outside boundaries of pictures, slices, tiles, or tile groups.

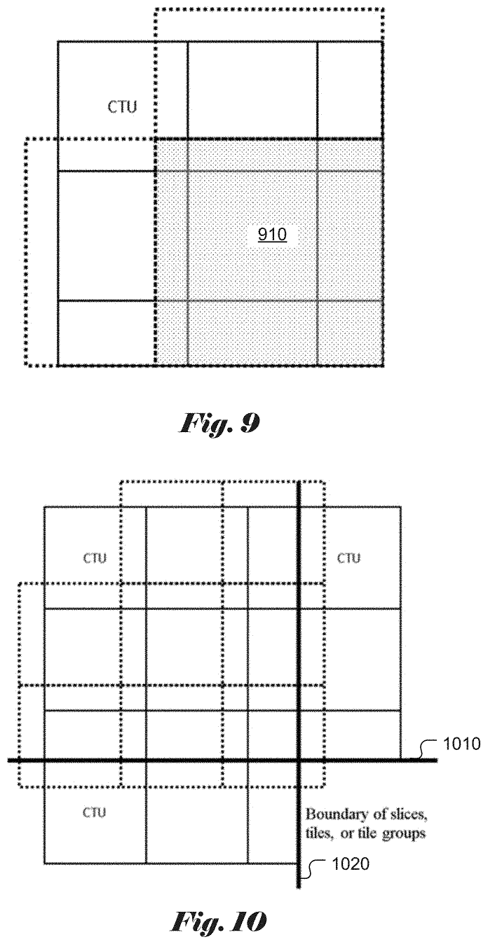

In one embodiment, the samples near the bottom and right boundary of pictures, slices, tiles, or tile groups, and can't form a complete CTU are specially handled. There are two solutions to solve this problem. One is to apply NN process four times as shown in FIG. 8, where processing regions 810, 820, 830 and 840 are processed separately. The other is to expand the region of NN processing to the boundary of pictures, slices, tiles, or tile groups, and only applying NN process once as shown in FIG. 9, where a bottom region is processed once (910) by expanding the area.

In one embodiment, as shown in FIG. 10, NN process can cross the boundaries (1010 and 1020) between two slices, tiles, or tile groups. In one embodiment, an on/off control flag can be used to indicate whether the NN process can cross the boundaries between two slices, tiles, or tile groups. The flag can be predefined, or explicitly transmitted in the bitstream such as at sequence level, picture level, slice level, tile level, or tile group level. The on/off control flag signaled at a high level can be overwritten by the flag signaled at a low level

The on/off control flags indicating whether NN can be enabled or disabled can be signaled to the decoder to further improve the performance of this framework. The on/off control flags can be signaled for a region, wherein each region corresponds to one sequence, one picture, one slice, one CTU row, one CTU, one CU, one PU, one TU, one block, or one N-by-N block, where N can be 4096, 2048, 1024, 512, 256, 128, 64, 32, 16, or 8.

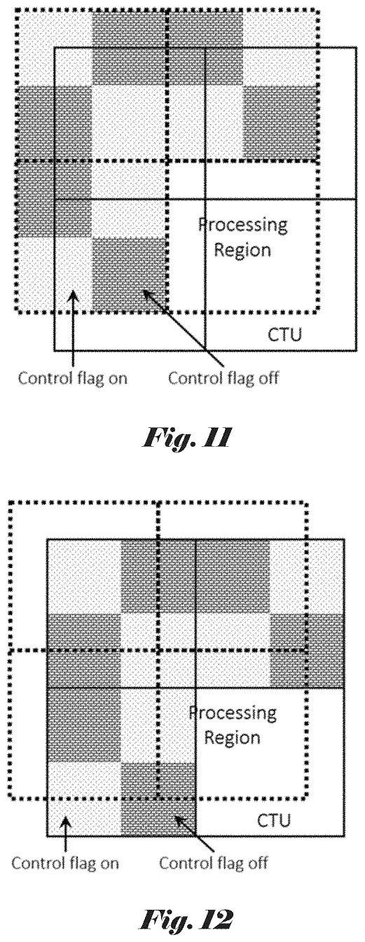

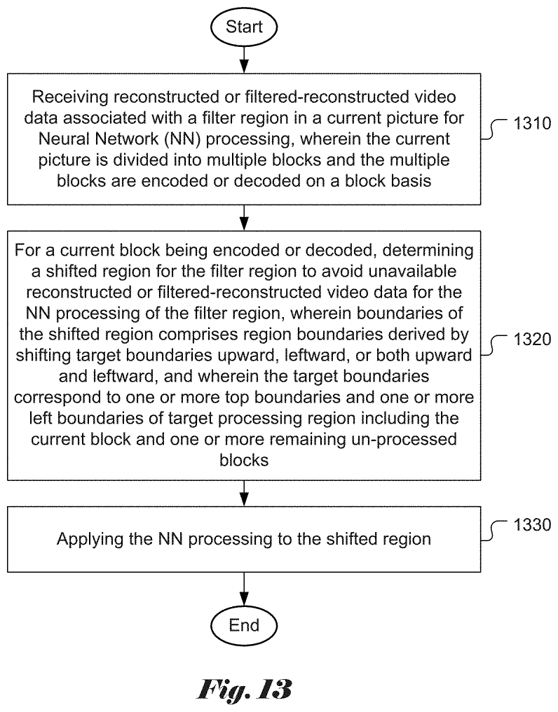

In one embodiment, the regions associated with on/off control flags can also be shifted toward above-left or above. An example is shown in FIG. 11, where the regions associated with the on/off control flags correspond to ¼ CTU and the regions are shifted toward above-left to align with the NN processing region. In another embodiment, the regions associated with on/off control flags are not shifted. An example is shown in FIG. 12, where the regions associated with the on/off control flags are ¼ CTU and the regions are aligned with the CTU boundary.

In one embodiment, for NN parameter sets signaling, the shortcut or the default NN parameter sets can be provided. For example, for a three-layer CNN, the NN parameter set for the first layer is chosen from default NN parameter sets and only the index of the default NN parameter set from the default NN parameter sets is signaled. The NN parameter sets for the second and the third layer are signaled in the bitstream. For another example, all NN parameter sets for all layers are chosen from default NN parameter sets and only the indexes of the default NN parameter set from the default NN parameter sets are signaled.

In one embodiment, one of the default NN parameter sets can be the sets that causes the inputs and the outputs to be identical. For example, for a three-layer CNN, the NN parameter sets for the first layer and the third layer can be signaled in the bitstream or chosen from default NN parameter sets and only the indexes of the default NN parameter set from the default NN parameter sets are signaled. For the second layer, the identical NN parameter set can be chosen. In this case, the three-layer CNN performs like a two-layer CNN.

The foregoing proposed method can be implemented in encoders and/or decoders. For example, the proposed method can be implemented in the in-loop filter module of an encoder, and/or the in-loop filter module of a decoder. Alternatively, any of the proposed methods could be implemented as a circuit coupled to the in-loop filter module of the encoder and/or the in-loop filter module of the decoder, so as to provide the information needed by the in-loop filter module.

FIG. 13 illustrates an exemplary flowchart of video coding incorporating the neural network (NN) according to one embodiment of the present invention, where the filter region is shifted up, left or both up and left. The steps shown in the flowchart may be implemented as program codes executable on one or more processors (e.g., one or more CPUs) at an encoder side or decoder side. The steps shown in the flowchart may also be implemented based hardware such as one or more electronic devices or processors arranged to perform the steps in the flowchart. According to this method, reconstructed or filtered-reconstructed video data associated with a filter region in a current picture are received for Neural Network (NN) processing in step 1310, wherein the current picture is divided into multiple blocks and the multiple blocks are encoded or decoded on a block basis. For a current block being encoded or decoded, a shifted region is determined for the filter region to avoid unavailable reconstructed or filtered-reconstructed video data for the NN processing of the filter region in step 1320, wherein boundaries of the shifted region comprises region boundaries derived by shifting target boundaries upward, leftward, or both upward and leftward, and wherein the target boundaries correspond to one or more top boundaries and one or more left boundaries of target processing region including the current block and one or more remaining un-processed blocks. The NN processing is applied to the shifted region in step 1330.

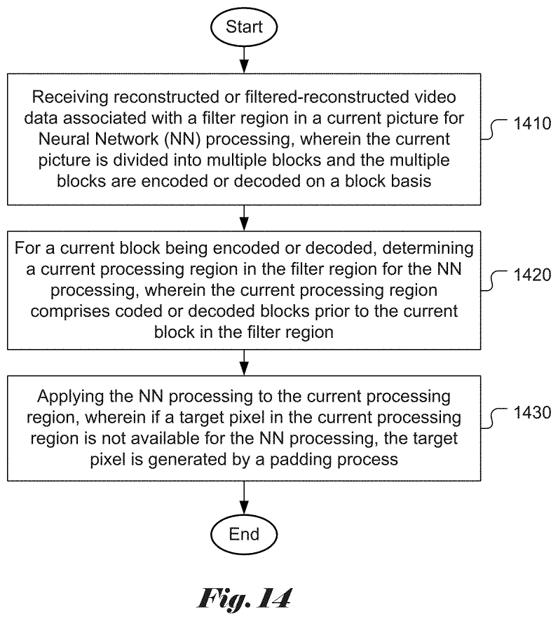

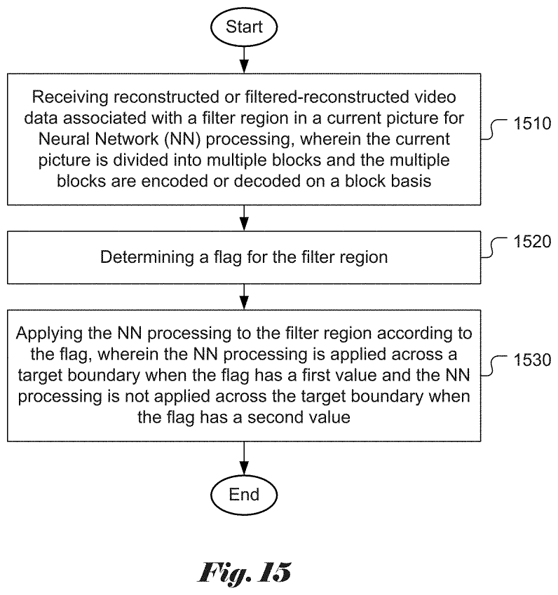

FIG. 14 illustrates an exemplary flowchart of video coding incorporating the neural network (NN) according to one embodiment of the present invention, where if a target pixel in the filter region is not available for the NN processing, the target pixel is generated by a padding process. According to this method, reconstructed or filtered-reconstructed video data associated with a filter region in a current picture are received for Neural Network (NN) processing in step 1410, wherein the current picture is divided into multiple blocks and the multiple blocks are encoded or decoded on a block basis. For a current block being encoded or decoded, a current processing region in the filter region is determined for the NN processing on the filter region in step 1420, wherein the current processing region comprises coded or decoded blocks prior to the current block in the filter region. The NN processing is applied to the current processing region in step 1430, wherein if a target pixel in the current processing region is not available for the NN processing, the target pixel is generated by a padding process.

FIG. 15 illustrates an exemplary flowchart of video coding incorporating the neural network (NN) according to one embodiment of the present invention, where whether the NN processing can be applied across a target boundary depends on a flag. According to this method, reconstructed or filtered-reconstructed video data associated with a filter region in a current picture are received for Neural Network (NN) processing in step 1510, wherein the current picture is divided into multiple blocks and the multiple blocks are encoded or decoded on a block basis. A flag for the filter region is determined in step 1520. The NN processing is applied to the filter region according to the flag in step 1530, wherein the NN processing is applied across a target boundary when the flag has a first value and the NN processing is not applied across the target boundary when the flag has a second value.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video processing for a video coding system, the method comprising:
receiving reconstructed or filtered-reconstructed video data associated with a filter region in a current picture for Neural Network (NN) processing, wherein the current picture is divided into multiple blocks and the multiple blocks are encoded or decoded on a block basis;
for a current block being encoded or decoded, determining a shifted region for the filter region to avoid unavailable reconstructed or filtered-reconstructed video data for the NN processing of the filter region, wherein boundaries of the shifted region comprises region boundaries derived by shifting target boundaries upward, leftward, or both upward and leftward, and wherein the target boundaries correspond to one or more top boundaries and one or more left boundaries of target processing region including the current block and one or more remaining un-processed blocks; and
applying the NN processing to the shifted region.

2. The method of claim 1, wherein the filter region corresponds to one picture, one slice, one coding tree unit (CTU) row, one CTU, one coding unit (CU), one prediction unit (PU), one transform unit (TU), one block, or one N×N block, and wherein the N corresponds to 4096, 2048, 1024, 512, 256, 128, 64, 32, 16, or 8.

3. The method of claim 1, wherein if a target pixel in the shifted region is outside the current picture, a current slice, a current tile, or a current tile group containing the current block, the NN processing is not applied to the target pixel.

4. The method of claim 1, wherein the current block corresponds to a coding tree unit (CTU).

5. The method of claim 1, wherein the NN processing corresponds to DNN (deep fully-connected feed-forward neural network), CNN (convolution neural network), or RNN (recurrent neural network).

6. The method of claim 1, wherein the filtered-reconstructed video data correspond to de-block filter (DF) processed data, DF and sample-adaptive-offset (SAO) processed data, or DF, SAO and adaptive loop filter (ALF) processed data.

7. An apparatus of video processing for a video coding system, the apparatus comprising one or more electronic circuits or processors arranged to:
receive reconstructed or filtered-reconstructed video data associated with a filter region in a current picture for Neural Network (NN) processing, wherein the current picture is divided into multiple blocks and the multiple blocks are encoded or decoded on a block basis;
for a current block being encoded or decoded, determine a shifted region for the filter region to avoid unavailable reconstructed or filtered-reconstructed video data for the NN processing of the filter region, wherein boundaries of the shifted region comprises region boundaries derived by shifting target boundaries upward, leftward, or both upward and leftward, and wherein the target boundaries correspond to one or more top boundaries and one or more left boundaries of target processing region including the current block and one or more remaining un-processed blocks; and
apply the NN processing to the shifted region.

8. A method of video processing for a video coding system, the method comprising:
receiving reconstructed or filtered-reconstructed video data associated with a filter region in a current picture for Neural Network (NN) processing, wherein the current picture is divided into multiple blocks and the multiple blocks are encoded or decoded on a block basis;
for a current block being encoded or decoded, determining a current processing region in the filter region for the NN processing, wherein the current processing region comprises coded or decoded blocks prior to the current block in the filter region; and
applying the NN processing to the current processing region, wherein if a target pixel in the current processing region is not available for the NN processing, the target pixel is generated by a padding process.

9. The method of claim 8, wherein the padding process corresponds to nearest pixel copy, odd mirroring or even mirroring.

10. The method of claim 8, wherein the filter region corresponds to one picture, one slice, one coding tree unit (CTU) row, one CTU, one coding unit (CU), one prediction unit (PU), one transform unit (TU), one block, or one N×N block, and wherein the N corresponds to 4096, 2048, 1024, 512, 256, 128, 64, 32, 16, or 8.

11. The method of claim 8, wherein the current block corresponds to a coding tree unit (CTU).

12. The method of claim 8, wherein the NN processing corresponds to DNN (deep fully-connected feed-forward neural network), CNN (convolution neural network), or RNN (recurrent neural network).

13. The method of claim 8, wherein the filtered-reconstructed video data correspond to de-block filter (DF) processed data, DF and sample-adaptive-offset (SAO) processed data, or DF, SAO and adaptive loop filter (ALF) processed data.

14. An apparatus of video processing for a video coding system, the apparatus comprising one or more electronic circuits or processors arranged to:
receive reconstructed or filtered-reconstructed video data associated with a filter region in a current picture for Neural Network (NN) processing, wherein the current picture is divided into multiple blocks and the multiple blocks are encoded or decoded on a block basis;
for a current block being encoded or decoded, determine a current processing region in the filter region for the NN processing, wherein the current processing region comprises coded or decoded blocks prior to the current block in the filter region; and
apply the NN processing to the current processing region, wherein if a target pixel in the current processing region is not available for the NN processing, the target pixel is generated by a padding process.

15. A method of video processing for a video coding system, the method comprising:
receiving reconstructed or filtered-reconstructed video data associated with a filter region in a current picture for Neural Network (NN) processing, wherein the current picture is divided into multiple blocks and the multiple blocks are encoded or decoded on a block basis;
determining a flag for the filter region; and
applying the NN processing to the filter region according to the flag, wherein the NN processing is applied across a target boundary when the flag has a first value and the NN processing is not applied across the target boundary when the flag has a second value.

16. The method of claim 15, wherein the flag is signalled at an encoder side or parsed at a decoder side.

17. The method of claim 15, wherein the flag is predefined.

18. The method of claim 15, wherein the flag is explicitly transmitted in a higher level of a bitstream corresponding to a sequence level, a picture level, a slice level, a tile level, or a tile group level.

19. The method of claim 15, wherein the flag at a higher level of a bitstream is overwritten by the flag at a lower level of the bitstream.

20. The method of claim 15, wherein the flag is signalled for one picture, one slice, one coding tree unit (CTU) row, one CTU, one coding unit (CU), one prediction unit (PU), one transform unit (TU), one block, or one N×N block, and wherein the N corresponds to 4096, 2048, 1024, 512, 256, 128, 64, 32, 16, or 8.

21. The method of claim 15, wherein the target boundary corresponds to one boundary between two slices, two tiles or two tile groups.

22. An apparatus of video processing for a video coding system, the apparatus comprising one or more electronic circuits or processors arranged to:
receive reconstructed or filtered-reconstructed video data associated with a filter region in a current picture for Neural Network (NN) processing, wherein the current picture is divided into multiple blocks and the multiple blocks are encoded or decoded on a block basis;
determine a flag for the filter region; and
apply the NN processing to the filter region according to the flag, wherein the NN processing is applied across a target boundary when the flag has a first value and the NN processing is not applied across the target boundary when the flag has a second value.
